(19) United States
(12) Patent Application Publication
(10) Pub. No.: US 2004/0197234 A1
(43) Pub. Date: Oct. 7, 2004

(54) Chemical substance detecting method and device

(76) Inventors: Michiaki Endo, Tokyo (JP); Kazuyuki Maruo, Tokyo (JP)

Correspondence Address: Muramatsu & Associates, Suite 225, 7700 Irvine Center Drive, Irvine, CA, 92618, US

(21) Appl. No.: 10/482,587

(22) PCT Filed: Jun. 12, 2002
(86) PCT No.: PCT/JP02/05843

(30) Foreign Application Priority Data
Jun. 28, 2001 (JP) 2001-196967
Oct. 19, 2001 (JP) 2001-322594

(51) Int. Cl. G01N 21/64; B32B 5/02

(52) U.S. Cl. 422/82.11; 436/164

(57) ABSTRACT

In a chemical substance detecting method for determining a chemical substance adsorbed to an infrared transmitting substrate by infrared multiple internal reflection method, a first light quantity in a first wavelength range where no substantial absorption of the infrared light takes place is measured in a state of the infrared transmitting substrate without a chemical substance adsorbed to, a second light quantity in the first wavelength range is measured in a state of the infrared transmitting substrate with a chemical substance adsorbed to, and a light quantity ratio between the first light quantity and the second light quantity is considered to compute an adsorption amount of the chemical substance adsorbed to the infrared transmitting substrate, whereby even when a light quantity of the transmitted infrared light is changed due to factors other than a chemical substance adsorbed to the substrate, the adsorption amount of the chemical substance can be precisely computed.

### TECHNICAL FIELD

The present invention relates to a chemical substance detecting method and apparatus, more specifically a chemical substance detecting method and apparatus which identify and determine chemical substances by infrared multiple internal reflection method.

### BACKGROUND ART

Identification of kinds of chemical substances and determination of their concentrations are required in various aspects. In fabrication processes for semiconductor devices, for example, to fabricate semiconductor devices of high quality with high fabrication yields it is necessary to measure and control chemical substances, such as organic contaminants, etc., adsorbed to semiconductor substrates being fabricated. For example, environmental pollution due to traces of chemicals, such as dioxins, etc., discharged from refuse incineration facilities, etc, and health damages due to chemical substances called VOC (Volatile Organic Compound) contained in construction materials of new houses and apartments are social problems. The measurement and control of chemical substances contained in the air are urgently required.

As one means for measuring such chemical substances, the inventors of the present invention, et al. have already proposed a method for monitoring chemical substances by infrared multiple internal reflection method (see, e.g., the Japanese Patent Application Unexamined Publication No. 2000-55815, the specification of Japanese Patent Application No. Hei 11-231495 (1999), etc.).

The chemical substance detecting method described in the Japanese Patent Application Unexamined Publication No. 2000-55815 analyzes the infrared light which has made multiple reflections inside an infrared transmitting substrate and exited the substrate to thereby identify kinds of chemicals adsorbed to the substrate and quantify their concentrations. Infrared light incident on one end of the infrared transmitting substrate at a specific incident angle propagates in the substrate, repeating total reflections on both surfaces. During the propagation, the infrared light penetrates at the substrate surfaces (evanescent light), and that of the evanescent light having a specific wavelength range is absorbed by chemical substances adsorbed to the surfaces. The propagating light exiting at the other end of the substrate is spectroscopically analyzed by FT-IR, and the chemical substances adsorbed to the surfaces of the substrate can be monitored and identified.

The chemical substance detecting method described in the specification of Japanese Patent Application No. Hei 11-231495 (1999) measures concentrations of chemical substances in the air by the chemical substance detecting method described in the Japanese Patent Application Unexamined Publication No. 2000-55815. An infrared transmitting substrate is exposed to an environment to be measured, and chemical substances on the substrate are measured by the infrared multiple internal reflection method to thereby compute concentrations of the chemical substances in the air, based on adhering quantities of the chemical substances adsorbed to the substrate.

These measuring methods have sensitivity equal to that of GC/MS method, etc. and can make real-time measurement and, in addition, are simple and economical. These measuring methods are non-destructive, and can measure semiconductor substrates in fabrication processes as they are.

However, in the conventional chemical substance detecting method described above, adhering quantities of chemical substances are computed based on absorbances of the transmitted infrared light, but when infrared light quantity changes due to causes other than the absorption by chemical substances take place, accurate adhering quantities cannot be given.

For example, a quantity of infrared light emitted by an infrared light source changes depending on changes of the room temperature. The infrared light source is a heating body of usually about 1000° C., and with an electric power inputted to the light source being constant, the temperature of the light source is determined by the room temperature. Accordingly, when the room temperature is low, the temperature of the light source is low, and the light quantity is decreased. Oppositely, when the room temperature is high, the light quantity is increased.

In the case that the multiple internal reflection substrate is a semiconductor substrate, when a temperature of the substrate changes, a quantity of the free carriers in the substrate changes. Since free carriers absorb infrared light, the transmittance of the infrared light through the multiple internal reflection substrate changes depending on changes of the substrate temperature.

When a quantity of infrared light transmitted by the substrate changes, the conventional chemical substance detecting methods cannot see whether the change is due to the absorption by chemical substances adsorbed to the substrate surfaces or due to other factors, and cannot compute accurate quantities of the chemical substances.

### DISCLOSURE OF INVENTION

An object of the present invention is to provide a chemical substance detecting method and apparatus which can accurately compute adhering quantities of chemical substances adsorbed to a substrate even when a quantity of transmitted infrared light is changed due to factors other than the chemical substances adsorbed to the substrate.

The above-described object is achieved by a chemical substance detecting method comprising: applying infrared light to an infrared transmitting substrate; detecting the infrared light which has made multiple internal reflections inside the infrared transmitting substrate and exited the infrared transmitting substrate; and computing an adsorption amount of a chemical substance adsorbed to the infrared transmitting substrate based on an intensity of the detected infrared light, wherein a first light quantity in a first wavelength range where no substantial absorption of the infrared light by the chemical substance takes place is measured in a reference state of the infrared transmitting substrate; a second light quantity in the first wavelength range is measured in a state of the infrared transmitting substrate with a quantity of the chemical substance changed; and a light quantity ratio between the first light quantity and the second light quantity is considered to compute the adsorption amount of the chemical substance adsorbed to the infrared transmitting substrate.

In the above-described chemical substance detecting method, it is possible that a third light quantity in a second wavelength range where the absorption of the infrared light by the chemical substance takes place is measured in the reference state of the infrared transmitting substrate; a fourth light quantity in the second wavelength range is measured in the state of the infrared transmitting substrate with a quantity of the chemical substance changed; and the fourth light quantity is corrected by using said light quantity ratio, and the adsorption amount of the chemical substance adsorbed to the infrared transmitting substrate is computed based on the third light quantity and the fourth light quantity as corrected.

In the above-described chemical substance detecting method, it is possible that a third light quantity in a second wavelength range where the absorption of the infrared light by the chemical substance takes place is measured in the reference state of the infrared transmitting substrate by using an infrared light source having a fifth light quantity; a fourth light quantity in the second wavelength range is measured in the state of the infrared transmitting substrate with a quantity of the chemical substance changed by using the infrared light source having a sixth light quantity which is the fifth light quantity corrected by using said light quantity ratio; and the adsorption amount of the chemical substance adsorbed to the infrared transmitting substrate is computed based on the third light quantity and the fourth light quantity.

In the above-described chemical substance detecting method, it is possible that a third light quantity in a second wavelength range where the absorption of the infrared light by the chemical substance takes place is measured in the reference state of the infrared transmitting substrate via a filter having a first pass characteristics; a fourth light quantity in the second wavelength range is measured in the state of the infrared transmitting substrate with a quantity of the chemical substance changed via the filter having a second pass characteristics which is the first pass characteristics corrected by using said light quantity ratio; and the adsorption amount of the chemical substance adsorbed to the infrared transmitting substrate is computed based on the third light quantity and the fourth light quantity.

In the above-described chemical substance detecting method, it is possible that the chemical substance contains a plurality of kinds chemical substances; the second wavelength range includes a plurality of wavelength ranges where the substantial absorption of the infrared light by the respective plurality of kinds of chemical substances takes place; and the third light quantity and the fourth light quantity are measured in the respective plurality of wavelength ranges to compute adsorption amounts of the respective plurality of kinds of chemical substances.

In the above-described chemical substance detecting method, it is possible that one of the plurality of kinds of chemical substances is determined in consideration of the absorption of the other of the plurality of kinds of chemical substances, which influences a change of the light quantities between the reference state and the measured state in a wavelength range where the absorption by said one chemical substance takes place.

In the above-described chemical substance detecting method, it is possible that the first wavelength range is a wavelength range near the second wavelength range.

In the above-described chemical substance detecting method, it is possible that a concentration of the chemical substance in the air is computed based on the adsorption amount of the chemical substance adsorbed to the infrared transmitting substrate.

The above-described object is also achieved by a chemical substance detecting apparatus comprising: an infrared transmitting substrate; an infrared light source for applying infrared light to the infrared transmitting substrate; and a chemical substance analyzing means for detecting the infrared light which has made multiple internal reflections in the infrared transmitting substrate and exited the infrared transmitting substrate, and computing an adsorption amount of the specific chemical substance adsorbed to the infrared transmitting substrate, the chemical substance analyzing means computing an adsorption amount of the specific chemical substance adsorbed to the infrared transmitting substrate in consideration of a light quantity ratio between a first light quantity in a first wavelength range where no substantial absorption of the infrared light by the chemical substance takes place measured in a reference state of the infrared transmitting substrate, and a second light quantity in the first wavelength range measured in a state of the infrared transmitting substrate with a quantity of the chemical substance changed.

In the above-described chemical substance detecting apparatus, it is possible that the apparatus further comprises a band-pass filter for passing selectively the infrared light in the first wavelength range or the infrared light in a second wavelength range which is near the first wavelength range and in which the absorption of the infrared light by the specific chemical substance takes place, and the chemical substance analyzing means analyzes the infrared light which has passed the band-pass filter.

In the above-described chemical substance detecting apparatus, it is possible that the band-pass filter includes a first filter which passes selectively the infrared light of the first wavelength range, and a second filter which passes selectively the infrared light of the second wavelength range.

In the above-described chemical substance detecting apparatus, it is possible that the band-pass filter can change the pass band to the first wavelength range and to the second wavelength range.

In the above-described chemical substance detecting apparatus, it is possible that the infrared light source emits infrared light of the first wavelength range and infrared light of a second wavelength range which is a wavelength range near the first wavelength range and in which the absorption of the infrared light by the specific chemical substance does not take place.

In the above-described chemical substance detecting apparatus, it is possible that the infrared light source includes a first light source for emitting infrared light of the first wavelength range, and a second light source for emitting infrared light of the second wavelength range.

In the above-described chemical substance detecting apparatus, it is possible that the infrared light source can change the emission wavelength range to the first wavelength range and to the second wavelength range.

In the above-described chemical substance detecting apparatus, it is possible that the chemical substance analyzing means includes an infrared detector which detects selectively the infrared light of the first wavelength range and the infrared light of a second wavelength range near the first wavelength range, in which the absorption of the infrared light by the specific chemical substance takes place.

In the above-described chemical substance detecting apparatus, it is possible that the infrared detector includes a first detecting element for detecting the infrared light of the first wavelength range, and a second detecting element for detecting the infrared light of the second wavelength range.

In the above-described chemical substance detecting apparatus, it is possible that the infrared detector can change the detection wavelength range to the first wavelength range and to the second wavelength range.

In the above-described chemical substance detecting apparatus, it is possible that the chemical substance contains a plurality of kinds of chemical substances; the second wavelength range includes a plurality of wavelength ranges in which the substantial absorption of the infrared light by the respective plurality of kinds of chemical substances takes place; and the chemical substance analyzing means corrects light quantities measured in the respective plurality of wavelength ranges in the state of the infrared transmitting substrate with the quantities of the chemical substances changed by using the light quantity ratio between the first light quantity and the second light quantity, and determines the respective plurality of kinds of chemical substances, based on the light quantities measured in the plurality of wavelength ranges in the reference state, and the light quantities as corrected in the plurality of wavelength ranges measured in the state of the infrared transmitting substrate with the quantities of the chemical substances changed.

In the above-described chemical substance detecting apparatus, it is possible that the chemical substance analyzing means determines one of the plurality of kinds of chemical substances in consideration of the absorption of the other of the plurality of kinds of chemical substances, which influences a change of the light quantities between the reference state and the measured state in a wavelength range where the absorption by said one chemical substance takes place.

According to the present invention, in the chemical substance detecting method comprising: applying infrared light to an infrared transmitting substrate; detecting the infrared light which has made multiple internal reflections inside the infrared transmitting substrate and exited the infrared transmitting substrate; and computing an adsorption amount of a chemical substance adsorbed to the infrared transmitting substrate based on an intensity of the detected infrared light, a first light quantity in a first wavelength range where no substantial absorption of the infrared light by the chemical substance takes place is measured in a reference state of the infrared transmitting substrate; a second light quantity in the first wavelength range is measured in a state of the infrared transmitting substrate with the chemical substance adsorbed to; and a light quantity ratio between the first light quantity and the second light quantity is considered to compute an adsorption amount of the chemical substance adsorbed to the infrared transmitting substrate, whereby even when a light quantity of the transmitted infrared light changes due to factors other than chemical substances adsorbed to the substrate, an adsorption amount of the a chemical substance can be precisely computed.

### BRIEF DESCRIPTION OF DRAWINGS

FIG. 1 is a diagrammatic view of a structure of the chemical substance detecting apparatus according to a first embodiment of the present invention.

FIG. 2 is graphs of examples of infrared spectra passed by the band-pass filter.

FIG. 3 is a view of one example of the band-pass filter in the chemical substance detecting apparatus according to the first embodiment of the present invention.

FIG. 4 is views explaining the determination of a chemical substance by the chemical substance detecting method according to the first embodiment of the present invention.

FIG. 5 is a graph of relationships between absorbances and residual carbon adsorbed to the substrate.

FIG. 6 is a graph of relationships between adhering quantities of a chemical substance adsorbed to the substrate and concentrations of the chemical substance in the air.

FIG. 7 is a diagrammatic view of a structure of the chemical substance detecting apparatus according to a second embodiment of the present invention.

FIG. 8 is a diagrammatic view of a modification example of the infrared light source of the chemical substance detecting apparatus according to a second embodiment of the present invention.

FIG. 9 is a view explaining the determination of a plurality of kinds of chemical substances in the chemical substance detecting method according to the present invention.

FIG. 10 is a view explaining the determination of chemical substances in the chemical substance detecting method according to a third embodiment of the present invention.

FIG. 11 is a view of an example of infrared absorbance spectrum in the case of applying the determination of chemical substances in the chemical substance detecting method according to the third embodiment of the present invention.

### BEST MODE FOR CARRYING OUT THE INVENTION

(A First Embodiment)

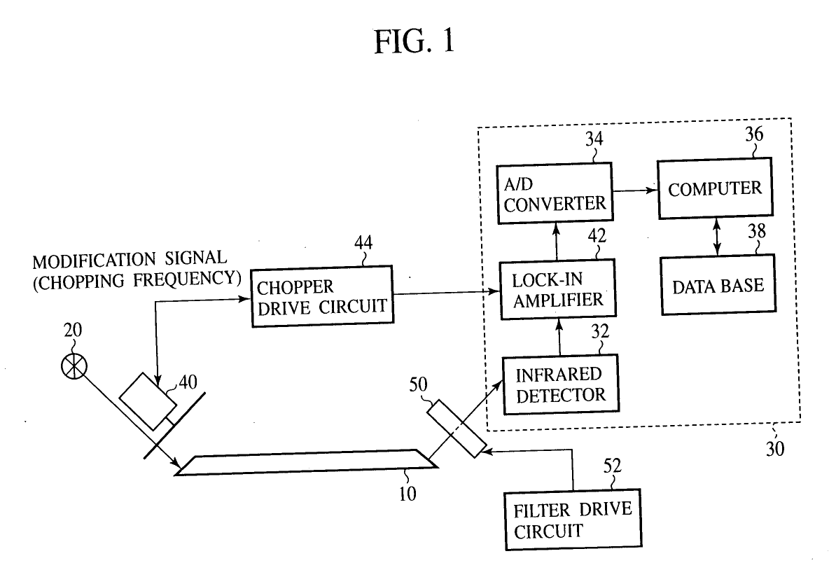

The chemical substance detecting method and apparatus according to a first embodiment of the present invention will be explained with reference to FIGS. 1 to 6.

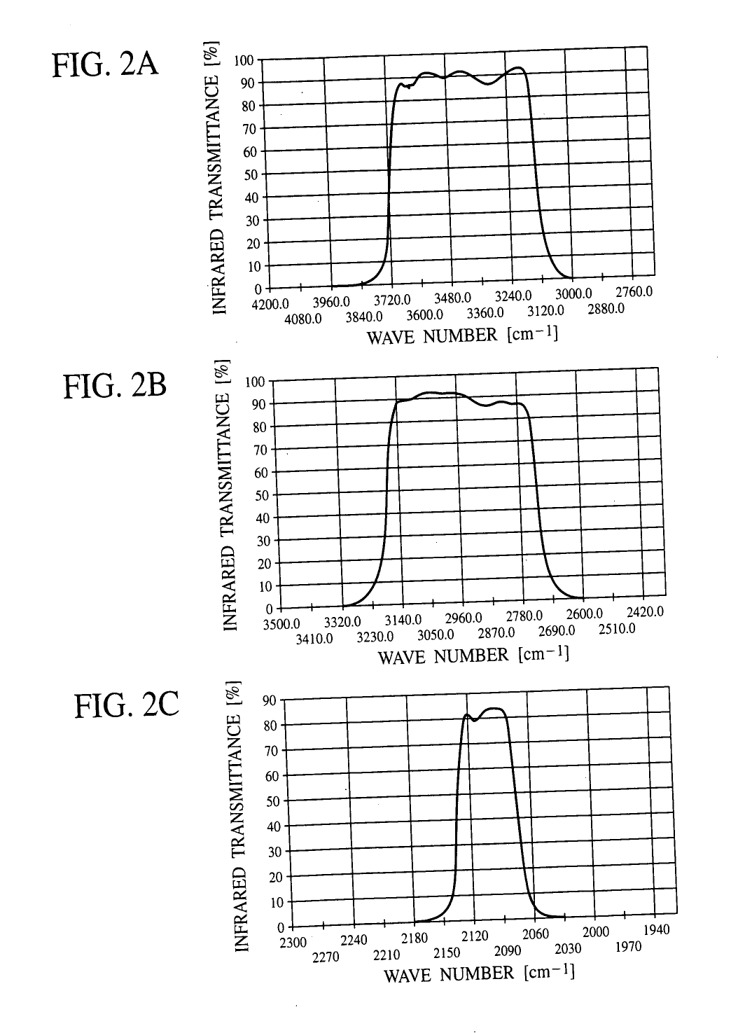

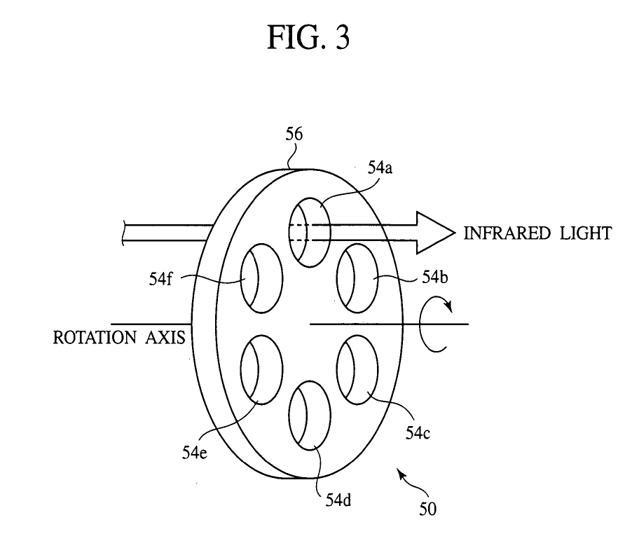

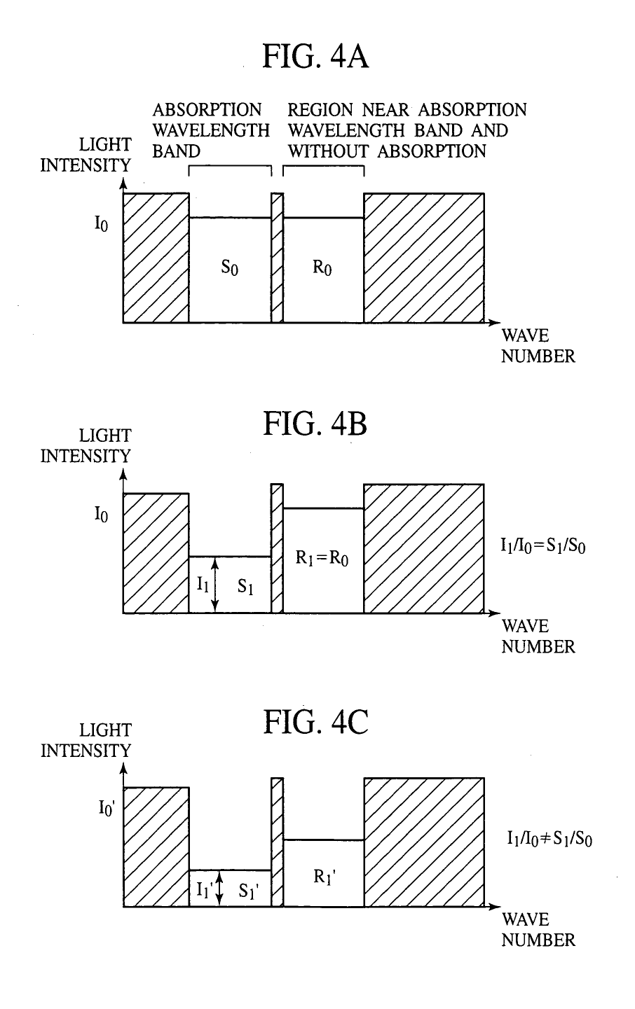

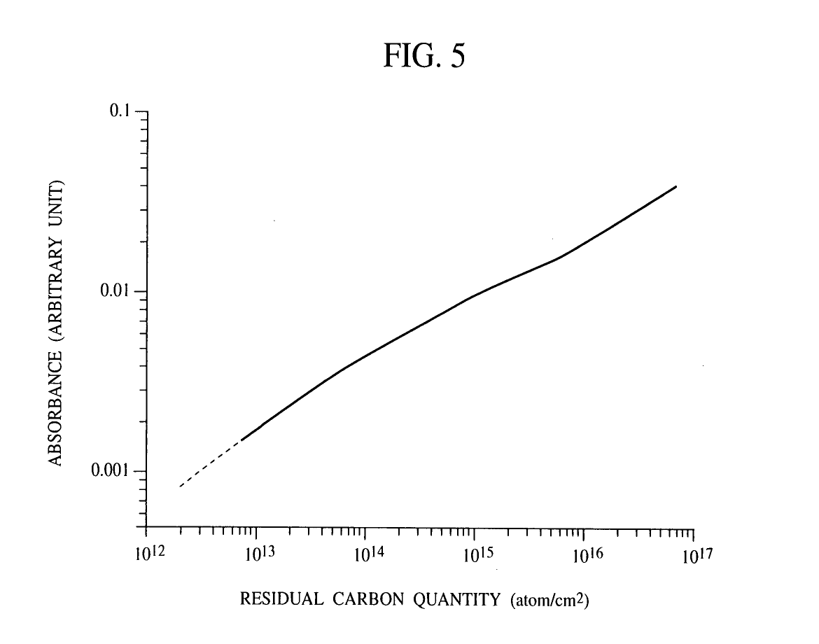

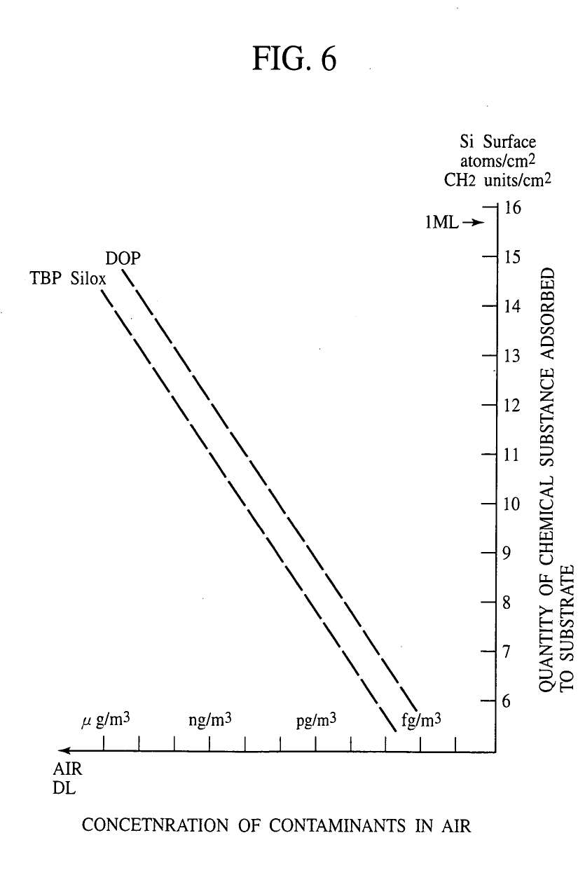

FIG. 1 is a diagrammatic view of the chemical substance detecting apparatus according to the present embodiment, which shows a structure thereof. FIG. 2 is graphs of spectra of infrared light passed by a band-pass filter. FIG. 3 is a view of one example of the band-pass filter in the chemical substance detecting apparatus according to the present embodiment. FIG. 4 is views explaining the determination of a chemical substance by the chemical substance detecting method according to the present embodiment. FIG. 5 is a graph of relationships between absorbances and residual carbon adsorbed to the substrate. FIG. 6 is a graph of relationships between adhering quantities of a chemical substance adsorbed to the substrate and concentrations of the chemical substance in the air.

[1] The General Structure of the Chemical Substance Detecting Apparatus

The structure of the chemical substance detecting apparatus according to the present embodiment will be explained with reference to FIG. 1.

On the side of one end surface of an infrared transmitting substrate 10 there is provided an infrared light source 20 which applies to the infrared transmitting substrate 10 infrared light which makes multiple internal reflections therein. On the side of the other end surface of the infrared transmitting substrate 10 there is provided chemical substance analyzing means 30 which detects the infrared light which has made multiple reflections inside the infrared transmitting substrate 10 and exited the infrared transmitting substrate 10 to analyze a chemical substance adsorbed to the infrared transmitting substrate 10 based on the detected infrared light.

The chemical substance analyzing means 30 includes an infrared detector 32 which detects the infrared light transmitted by the infrared transmitting substrate to convert the infrared light to electric signals, an A/D converter for converting the electric signals outputted from the infrared detector 32 to digital signals, a computer 36 for computing an adsorption amount of a chemical substance adsorbed to the infrared transmitting substrate 10, based on output signals from the A/D converter 34, and a data base 38 to be referred to in determining the chemical substance.

A chopper 40 is disposed between the infrared light source 20 and the infrared transmitting substrate 10. A lock-in amplifier 42 is disposed between the infrared detector 32 and the A/D converter 34. The chopper 40 and the lock-in amplifier 42 are equipped with a chopper drive circuit 44 so that the chopping frequency of the chopper 40 and the detection of the infrared light by the infrared detector 32 can be synchronized by the chopper drive circuit 44.

A band-pass filter 50 having at least two filters of different pass bands is disposed between the infrared transmitting substrate 10 and the infrared detector 32. The band-pass filter 50 is connected to a filter drive circuit 52 so that one kind of the filters of the band pass filter 50 is changed to control a pass band of the infrared light for the infrared light to be detected by the infrared detector 32.

The respective constituent members of the environmental monitoring apparatus according to the present embodiment will be detailed below.

(a) The Infrared Transmitting Substrate 10

The infrared transmitting substrate 10 is a substrate (e.g., a semiconductor substrate) to be measured, or a substrate which adsorbs a chemical substance to be measured in an atmosphere for the measurement. The infrared transmitting substrate 10 must be a material which transmits light of wavelength ranges corresponding molecular vibrations of chemical substances to be measured. The wave number range corresponding to the basic vibrations of the organic substances, which are typical chemical substances, is the infrared and near infrared range of about 500 cm⁻¹ (wavelength: 20 μm)−5000 cm⁻¹ (wavelength: 20 μm) Accordingly, a material of the infrared transmitting substrate 10 is selected out of an infrared transmitting material group, which can transmit the light of such wave number range (wavelength range).

Materials which transmit the light of the infrared and near infrared range are, e.g., silicon (Si: transmitted wavelength range: 1.2-6 μm), potassium bromide (KBr: transmitted wavelength range: 0.4-22 μm), potassium chloride (KCl: transmitted wavelength range: 0.3-15 μm), zinc selenide (ZnSe: transmitted wavelength range 0.6-13 μm), barium fluoride (BaF₂: transmitted wavelength range: 0.2-5 μm), caesium bromide (CsBr: transmitted avelength range: 0.5-30 μm), germanium (Ge: transmitted wavelength range 2-18 μm), lithium fluoride (LiF: transmitted wavelengh range 0.2-5 μm), calcium fluoride (CaF₂: transmitted wavelength range 0.2-8 μm), sapphire (Al₂O₃: transmitted wavelength range: 0.3-5 μm), caesium iodide (CsI: transmitted wavelength range: 0.5-28 μm), magnesium fluoride (MgF₂: transmitted wavelength range: 0.2-6 μm), thallium bromide (KRS-5: transmitted wavelength range: 0.6-28 μm), zinc sulfide (ZnS: transmitted wavelength range: 0.7-11 μm), etc. The infrared transmitting substrate 10 can be formed of these materials. Some of these materials have deliquescence unsuitably to be used in all environments. It is preferable that a material of the infrared transmitting substrate 10 is suitably selected in accordance with an environment for the infrared transmitting substrate 10 to be used in and a transmission wavelength range.

The infrared transmitting substrate 10 can have the elongate configuration having the end surfaces tapered by 45° as exemplified in FIG. 1. A substrate having a plurality of infrared propagation lengths as described in, e.g., the specification of Japanese Patent Application No. Hei 11-231495 (1999) may be used. A 300 mm-silicon wafer as described in, e.g., the Japanese Patent Application Unexamined Publication No. 2000-55815 may be used as it is.

(b) The Infrared Light Source 20

The infrared light source 20 can be a light source which can emit infrared light of a 2-25 μm band corresponding to the molecular vibrations of the organic molecules.

For example, heat rays emitted by applying current to silicon carbide (SiC) or a nichrome wire as a filament can be used as the light source. Light sources, such as SiC globe lanterns, etc., using SiC are characterized in that they emit infrared light of a 1.1-25 μm-band and are not burned even in naked uses in the air.

As the infrared light source 20, semiconductor laser and light emitting diodes having emission wavelengths which are in the infrared and near infrared range can be used. The light sources, such as semiconductor lasers and the light emitting diodes, are characterized by being small sized and being able to make small focuses on the end surface of the substrate.

A reflecting plate having a suitable configuration may be provided for higher efficiency of the light source and higher intensities of the infrared light. For example, the various infrared light sources described in the specification of Japanese Patent Application No. Hei 11-95853 (1999) can be used.

(c) The Band-Pass Filter 50

The band-pass filter 50 has at least two filters of different pass bands. One of the two filters having different pass bands is a band-pass filter which passes infrared light of a wavelength range corresponding to the molecular vibrations of a functional group (e.g., C—H group, O—H group, Si—H group or others) characteristic of a chemical substance to be measured. For example, when a chemical substance which exhibits infrared absorption due to C—H stretching vibrations is measured, a filter whose pass band is near a 2800-3000 cm⁻¹ wave number is used. The other band-pass filter is a band-pass filter which passes infrared light of a wavelength range which is near the wavelength range corresponding to the molecular vibrations of the functional group characteristic of the chemical substance to be measured and in which infrared absorption does not substantially take place. For example, when a chemical substance which exhibits infrared absorption due to the C—H stretching vibrations is measured, a filter having the pass band near, e.g., a 2700 cm⁻¹ wave number or a 3100 cm⁻¹ wave number is used. When a chemical substance is monitored based on molecular vibrations of a plurality of functional groups, a plurality of sets of filters are provided for prescribed functional groups.

Infrared band-pass filters corresponding to the vibrational wavelengths of specific functional groups are marketed by, e.g., SPECTROGON, U.S.A. FIG. 2 is graphs of examples of infrared transmission spectra given by the infrared band-pass filters marketed by SPECTROGON. FIGS. 2A, 2B and 2C are the spectra given by the filter passing the wavelength range corresponding to the molecular vibrations of O—H group, the filter passing the wavelength range corresponding to the molecular vibrations of C—H group, and the filter passing the wavelength range corresponding to the molecular vibrations of Si—H group. The band-pass filter 50 of the chemical substance detecting apparatus according to the present embodiment can be such filters.

The band-pass filter 50 is connected to the filter drive circuit 52 and have the above-described filters changed by a controller for controlling the measuring system via the filter drive circuit 52. As exemplified in FIG. 3, the band-pass filter 50 having a plurality of filters 54a-54f provided on a rotary plate 56 along one concentric line is prepared, and the rotary plate 56 is rotated along the rotary axis to thereby change the filter 54a-54f which passes the infrared light exiting the infrared transmitting substrate 10.

(d) The Chemical Substance Analyzing Means 30

As shown in FIG. 1, the chemical substance analyzing means 30 comprises the infrared detector 32 which detects infrared light transmitted by the infrared transmitting substrate and converts the detected infrared light to electric signals, the A/D converter 34 which converts the electric signals output by the infrared detector 32 to digital signals, the computer 36 which computes an adsorption amount of a chemical substance adsorbed to the infrared transmitting substrate 10, based on the outputted signals from the A/D converter 34, and a data base 38 to be referred to for determining the chemical substance.

The infrared light exiting the infrared transmitting substrate 10 passes through the band-pass filter 50 to be incident on the chemical substance analyzing means 30. The filter of the band-pass filter 50 is set to be the filter which passes a wavelength range corresponding to the molecular vibrations of a functional group characteristic of a chemical substance to be measured, whereby the intensity of the infrared light detected by the infrared detector 32 reflects an adsorption amount of the chemical substance adsorbed to the infrared transmitting substrate 10. The intensity of the infrared light detected by the infrared detector 32 is referred to prescribed reference quantities, whereby the adsorption amount of the chemical substance on the infrared transmitting substrate 10 can be computed.

Kinds of chemical substances and calibration curves are stored separately in the data base 38, and measured data are referred to the data for the determination. In the data base 38, relationships between quantities of chemical substances adsorbed on the surfaces of the infrared transmitting substrate 10 and quantities of the chemical substances in the air are stored as a data base, and based on the measured quantities of chemical substances on the surfaces of the infrared transmitting substrate 10, concentrations of the chemical substances in the air can be computed. The method determining adsorption amounts of chemical substances and concentrations of the chemical substances will be described later.

A display (not shown) may be connected to the computer 36 to display analysis results given by the computer 36.

In the chemical substance detecting apparatus according to the present embodiment, the chopper 40 is disposed between the infrared light source 20 and the infrared transmitting substrate 10 and is driven by the chopper drive circuit 44, and the lock-in amplifier 42 is disposed between the infrared detector 32 and the A/D converter 34. The chopping frequency of the chopper 40 and the detection of the infrared light are synchronized, whereby the S/N ratio can be improved. The chopper 40, chopper drive circuit 44 and the lock-in amplifier 42 may not be essentially provided.

[2] Determination of Adsorption Amount of Chemical Substance on Infrared Transmitting Substrate

The computation of an adsorption amount of a chemical substance adsorbed to the substrate by the chemical substance detecting method according to the present embodiment will be explained with reference to FIGS. 4 and 5.

In the chemical substance detecting method according to the present embodiment, an adsorption amount of a chemical substance on the infrared transmitting substrate 10 is computed, based on a correction value given by measuring light quantities in a plurality of wavelength ranges, correcting changes of the light quantities, based on an absolute value of the light quantities and relative relationships among them. The computing method of the adsorption amount will detailed below.

Generally, when light of a light quantity I₀ is transmitted by an object of a thickness d and an absorption coefficient α, a transmitted light quantity I₁ of the light which has undergone the absorption by the object is expressed by

I₁=L₀ exp(−αd) (1).

Accordingly, when the absorption coefficient α and the thickness d are decided, the exponential function part of Expression (1) is a constant. That is, the light quantity I₁ of the transmitted light is changed in proportion with changes of the light quantity I₀ of the incident light. At this time, the value of I₁/I₀ is a constant value. The absorption due to the multiple internal reflections can be treated as the light transmitted by the object having a thickness equivalent to a quantity of the absorption by the multiple internal reflections.

However, it is considered that a light quantity in a region in which the infrared absorption takes place is influenced also by light quantity changes due to light quantity changes of the light source and due to the light absorption by free carriers accompanying substrate temperature changes other than due to the light absorption by objects (chemical substances) adsorbed to the substrate surfaces, which is given by Expression (1). Thus, in order to correctly give a light absorption by a substance adsorbed to the substrate surfaces, the detected transmitted light quantities must be corrected.

Then, the procedures for correctly giving a light absorption alone by a substance adsorbed to the substrate surfaces will be explained with reference to FIG. 4.

First, in the reference state, a light quantity S₀ in an absorption wavelength range characteristic of a chemical substance to be measured, and a light quantity R₀ in a wavelength range which is near this wavelength range and in which the absorption does not take place are measured (FIG. 4A). The reference state means not only a state of the substrate, e.g., immediately after the substrate has been cleaned, where no chemical substance is considered to be on the substrate, but also the state of the substrate, e.g., before cleaned or before surface-treated, where the surfaces of the substrate are not perfectly clean.

Then, on the substrate in the measurable state, a light quantity S₁ in the absorption wavelength region characteristic of a chemical substance to be measured, and a light quantity R₁ in the wavelength region near this wavelength region and in which the absorption does not take place are measured. The measurable state means here a state where a quantity of a chemical substance on the substrate has changed in comparison with that in the reference state.

When a certain quantity of a chemical substance adheres to the substrate, with a light quantity R₁ in the measurable state being equal to a light quantity R₀ in the reference state, a light quantity ratio I₁/I₀ is considered to be equal to a light quantity ratio S₁/S₀ in the band where the absorption takes place. Accordingly, based on the light quantity ratio S₁/S₀, a correct absorbance by the chemical substance alone adsorbed to the substrate can be computed (FIG. 4B).

In contrast to this, when a light quantity R₁′ in the measurable state is different from a light quantity R₀ in the reference state, a light quantity ratio I₁/I₀ is different from a light quantity ratio S₁′/S₀ in the band where the absorption takes place. A correct absorbance by the chemical substance alone adsorbed to the substrate cannot be computed based on the light quantity ratio S₁′/S₀ (FIG. 4C). Here, the light quantity R₁′-indicates a light quantity R₁ which is different from a light quantity R₀ in the reference state, and the light quantity S₁′ indicates the light quantity S₁ in the band where the absorption takes place with the light quantity R₀ and the light quantity R₁ being different from each other. When an incident light quantity I₁ and a transmitted light quantity I₀ in the case that the light quantity R₀ and the light quantity R₁ are different from each other are represented respectively by I₁′ and Iₒ′, the conditions of Expression (1) hold even with the light quantities are changed. The ratio of the light quantities I₁′/I₀′ is

I₁′/I₀′=I₁/I₀ (2).

Then, to correct the light quantity in the absorption wavelength range, the transmitted light quantity S₁′ in this region is multiplied with an inverse (R₀/R₁′) of a change ratio of the light quantity in the region without the light absorption. That is, a light quantity S₁″ after corrected is expressed by

Si₁″=S₁′×(R₀/R₁′) (3).

An absorbance A after corrected can be computed by

A=−log₁₀(S₁″/S₀) (4).

By this correction, I₁′/I₀′=S₁″/S₀. Therefore the correct absorbance can be computed.

The same correction can be made by changing the light quantity of the infrared light source 20 and pass characteristics of the band-pass filter 50 in place of correcting the absolute value of the light quantity S₁′ as described above.

In changing the light quantity of the infrared light source 20, the light quantities R₀, R₁′ are measured with the light quantity of the infrared light source 20 being I₁′, and then the light quantity of the infrared light source 20 is changed to I₁′×(R₀/R₁′) to measure the light quantity S₁′. Thus, the absorbance A can be computed by

A=−log₁₀(S₁′/S₀) (5).

Similarly in changing pass characteristics of the band-pass filter 50, the light quantities R₀, R₁′ are measured with the pass rate of the band-pass filter being T, and then the pass rate of the band-pass filter is changed to T×(R₁′/R₀) to measure the light quantity S₁′. Thus, the absorbance A can be computed by Expression (5).

To compute an adsorption amount per a unit area of a chemical substance on the substrate, a calibration line is prepared in advance by, e.g., the following procedures, and based on the calibration line, the determination is performed.

(1) First, a plurality of solutions of a chemical substance of different concentrations diluted with a volatile solvent are prepared.

(2) Then, these solutions are applied in a certain quantity to the substrate.

(3) Then, let the substrates with the solutions applied to stand for a suitable period of time to evaporate the solvent.

(4) Then, the intensities of the absorbances of a chemical substance adsorbed to the substrates are computed by multiple internal reflection method. In computing the absorbances, the above-described correction of the transmitted light quantities is performed.

(5) Then, based on the concentrations of the solutions, the applied quantities and the substrate areas, the adsorption amounts of the chemical substance per the unit area are computed.

(6) Next, the calibration line is prepared based on relationships between the adsorption amounts and the absorbances.

From the thus-prepared calibration line, the relationships between the absorbances and the adsorption amounts in the measurable state are read to thereby give an absolute amount of the chemical substance adsorbed to the infrared transmitting substrate 10.

FIG. 5 is a calibration line showing the relationships between the absorbances and the residual carbon quantities, which was prepared by using samples of 300 mm-silicon wafers with DOP diluted with ethanol uniformly applied to. The calibration line of FIG. 5 shows that when the absorbance of the infrared light is 0.01, the residual carbon quantity on the wafer is 1×10¹⁵ cm⁻².

The calibration lines as shown in FIG. 5 are prepared in advance and stored in the data base 38, whereby adsorption amounts of chemical substance adsorbed to the infrared transmitting substrate 10 can be computed based on absorbances of the infrared light.

[3] Determination of Chemical Substance Concentrations in an Atmosphere

The computation of a concentration of a chemical substance in the air by the chemical substance detecting method according to the present embodiment will be explained with reference to FIG. 6.

In the chemical substance detecting method according to the present invention, the quantity of a chemical substance present adsorbed to the infrared transmitting substrate 10 or near the infrared transmitting substrate 10 is measured by multiple internal reflection infrared spectroscopic method and is converted to a chemical substance concentration in an atmosphere. That is, a chemical substance concentration in an atmosphere is not directly measured. Accordingly, to give a concentration of a chemical substance in an atmosphere, based on a quantity of the chemical substance present near the infrared transmitting substrate 10, relationships between the concentrations of the chemical substance and the intensity of the absorbance at the infrared absorption peak must be obtained in advance, and a calibration line must be prepared. For only the purpose of computing a chemical substance concentration in an atmosphere, it is not necessary to compute as described above the absolute value of the chemical substance adsorbed to the infrared transmitting substrate 10.

In preparing a calibration line indicating relationships between chemical substance concentrations in an atmosphere and an intensity of the absorbance of the absorption peak, first their relationships will be considered.

Chemical substances more tend to adhere to the infrared transmitting substrate 10 as their concentrations in an atmosphere are higher. Accordingly, adsorption amounts of chemical substances on the infrared transmitting substrate 10 are larger as their concentrations in an atmosphere increase. Here, when a concentration of a chemical substance in an atmosphere is represented by C; a conversion coefficient between an adsorption amount and a concentration, K₁; and an adsorption amount of the chemical substance on the infrared transmitting substrate 10, W, the following relational expression holds among them:

C=K₁×W (6).

On the other hand, a transmitted light quantity I₁ after a chemical substance has been adsorbed to the infrared transmitting substrate 10 can be expressed by the following expression when a transmitted light quantity before adsorption is represented by I₀; an internal reflection time, N; and an adsorption coefficient per a unit area for one reflection, α.

I₁=I₀×exp(—W×N×α) (7).

An absorbance A is expressed by

A=−log₁₀(I₁/I₀) (8).

By using Expressions (7) and (8), an absorbance A is given by

A∝W×N×α (9).

Accordingly, Expression (6) is rewritten as follows when a conversion coefficient between an absorbance and a concentration is represented by K₂.

C=K₂×A (10)

Based on Expression (6) and Expression (10), it is seen that proportional relationships hold between a concentration of a chemical substance and an adsorption amount of the chemical substance on the substrate, and between a concentration of a chemical substance and an absorbance of the chemical substance. Accordingly, an amount of a chemical substance adsorbed to the infrared transmitting substrate 10 exposed to an atmosphere is given based on the absorbance, and the result is multiplied with the conversion coefficient to thereby compute the concentration of the chemical substance in the atmosphere.

The conversion coefficient can be measured by, e.g., the following procedures.

(1) The infrared transmitting substrate 10 is exposed in a space where a chemical substance is present in a certain concentration.

(2) Next, the concentration of the chemical substance in a gas is measured by another means (a gas detecting tube, a gas chromatography, or others).

(3) Next, the intensity of the absorbance of a peak of the absorption by the chemical substance adsorbed to the infrared transmitting substrate 10 is measured by multiple internal reflection method.

(4) Next, the procedures (1) to (3) described above are repeated for the spaces of a plurality of chemical substance concentrations, and based on ratios between the results of the procedures (2) and (3), a conversion coefficient is given.

The exposing periods of time of the substrate are preferably constant, because the different exposing periods of time make the adsorption amount of a chemical substance of even one concentration often vary, and in this case, the intensity of the absorbance must be converted so that the exposing periods of time become equal. To this end, it is necessary to give in advance relationships between the exposing period of time and the intensity of the absorbance by measuring intensities of the absorbance at a suitable interval while the infrared transmitting substrate 10 is being exposed to an atmosphere.

To make the measurement precise, conditions for the internal reflections are the same, and the infrared light must be incident on one and the same substrate or substrate of one configuration under the same conditions. The absorbance coefficient varies depending on kinds of chemical substances, and for the precise determination, the conversion coefficients must be measured in advance for all substances to be determined.

FIG. 6 is a graph of relationships between concentrations of chemical substances in the air and the surface contamination of silicon wafers as the infrared transmitting substrate left in the air for 24 hours. In the case of DOP (dioctyl phthalate), when the wafer is left for 24 hours in the air of, e.g., a 1 ng/m³ DOP concentration, the adsorption amount of the DOP on the wafer surfaces is 10¹² CH₂ unit/cm². To say in the reversed way, when the adsorption amount after left for 24 hours is 10¹² CH₂ unit/cm², the DOP concentration in the air is found to be 1 ng/m³. On the other hand, as seen in the case of TBP (tributyl phosphate: flame retardant) and siloxane (volatile substance from silicon caulking agents), the relationships between the concentration in the air and the adsorption amount differs depending on conditions of chemical substances, standing hours, etc. Accordingly, it is necessary to give in advance the relationships between the concentrations in the air and the adsorption amounts for each chemical substance.

The calibration lines as shown in FIG. 6 is prepared in advance and stored in the data base 38, whereby a concentration of a chemical substance in an atmosphere can be computed, based on an adsorption amount of the chemical substance adsorbed to the infrared transmitting substrate 10. It is possible that a calibration line of relationships between concentrations of chemical substances in an atmosphere and intensities of absorbances of absorption peaks is prepared in advance in place of the calibration line shown in FIG. 6, and the calibration line is stored in the data base 38, whereby concentrations of the chemical substances in an atmosphere air are computed.

[4] Chemical Substance Detecting Method

The chemical substance detecting method according to the present embodiment will be explained with reference to FIG. 1.

First, before the measurement is performed on the substrate in the measurable state, the measurement is made on the substrate in the reference state. The measurement in the reference state may be performed at the time of measuring each measurable substrate, or periodically (e.g., every treatment of a prescribed number of the substrates).

a reference substrate with no chemical substance adsorbed to the surfaces, such as the substrate immediately after cleaned, is loaded in the chemical substance detecting apparatus.

Then, infrared light is applied to the reference substrate from the infrared light source 20. The infrared light entering the reference substrate makes multiple internal reflection on the front and back surfaces of the substrate and exits the substrate outside.

Next, the infrared light which has exited the infrared transmitting substrate 10 is detected by the infrared detector 32. At this time, in order to measure a plurality of wavelengths, kinds of the band-pass filter 50 are changed to make the measurement at least twice. In the first measurement, the infrared light which has passed the band-pass filter passing the absorption band wavelength of the absorption by a chemical substance to be measured is detected. In the second measurement, the infrared light which has passed the band-pass filter passing the wavelength band which is near the absorption band of the absorption by the chemical substance to be measured and where the absorption by the chemical substance does not take place is detected. Either of the two measurements described above may be made first.

The light quantity of the infrared light detected by the first measurement is stored in the data base 38 as, e.g., a light quantity S₀. The light quantity of the infrared light detected by the second measurement is stored in the data base 38 as, e.g., a light quantity R₀.

Then, the measurement is made on the measurable substrate.

First, the infrared transmitting substrate 10 which is the measurable substrate is loaded in the chemical substance detecting apparatus. The infrared transmitting substrate 10 may be positioned in an atmosphere to be monitored to monitor chemical substances contained in the atmosphere.

Next, infrared light is incident on the infrared transmitting substrate 10 from the infrared light source 20. The infrared light incident on the infrared transmitting substrate 10 makes multiple internal reflections on the front and back surfaces of the infrared transmitting substrate 10 while probing and accumulating information of a chemical substance adsorbed to the surfaces of the infrared transmitting substrate 10, and exits the infrared transmitting substrate 10 outside.

Then, the infrared light which has exited the infrared transmitting substrate 10 is detected by the infrared detector 32. At this time, in order to measure a plurality of wavelengths, kinds of the band-pass filter 50 are changed to make the measurement at least twice. In the first measurement, the infrared light which has passed the band-pass filter passing the absorption band wavelength of the absorption by a chemical substance to be measured is detected. In the second measurement, the infrared light which has passed the band-pass filter passing the wavelength band which is near the absorption band of the absorption by the chemical substance to be measured and in which the absorption by the chemical substance does not take place is detected. Either of the two measurements described above may be made first.

The light quantity of the infrared light detected by the first measurement is stored in the data base 38 as, e.g., a light quantity S₁′. The light quantity of the infrared light detected by the second measurement is stored in the data base 38 as, e.g., a light quantity R₁′.

Then, based on the light quantities S₀, R₀, S₁′, R₁′ stored in the data base 38, an absorbance A with the transmitted light quantity corrected is given. That is, the absorbance A can be computed by

A=−log₁₀(S₁′×(R₀/R₁′)/S₂).

Next, with reference to a prescribed calibration line stored in the data base 38, an adsorption amount of the chemical substance adsorbed to the infrared transmitting substrate 10, or a concentration of the chemical substance in the atmosphere is computed.

As described above, according to the present embodiment, in the chemical substance detecting method comprising: applying infrared light to an infrared transmitting substrate; detecting the infrared light which has made multiple internal reflections inside the infrared transmitting substrate and exited the infrared transmitting substrate; and computing an adsorption amount of a chemical substance adsorbed to the infrared transmitting substrate based on an intensity of the detected infrared light, a first light quantity in a first wavelength range where no substantial absorption of the infrared light by the chemical substance takes place is measured in a reference state of the infrared transmitting substrate; a second light quantity in the first wavelength range is measured in a state of the infrared transmitting substrate with the chemical substance adsorbed to; and a light quantity ratio between the first light quantity and the second light quantity is considered to compute an adsorption amount of the chemical substance adsorbed to the infrared transmitting substrate, whereby even when a light quantity of the transmitted infrared light changes due to factors other than chemical substances adsorbed to the substrate, an adsorption amount of the a chemical substance can be precisely computed.

In the present embodiment, the band-pass filter 50 is disposed between the infrared transmitting substrate 10 and the infrared detector 32, but the band-pass filter 50 may be disposed between the infrared light source 20 and the infrared transmitting substrate 10.

In the present embodiment, a plurality of filters having different pass-bands is used for the detection, but in place of a plurality of filters, a band-pass filter having variable pass-bands may be used in the same measurement.

(A Second Embodiment)

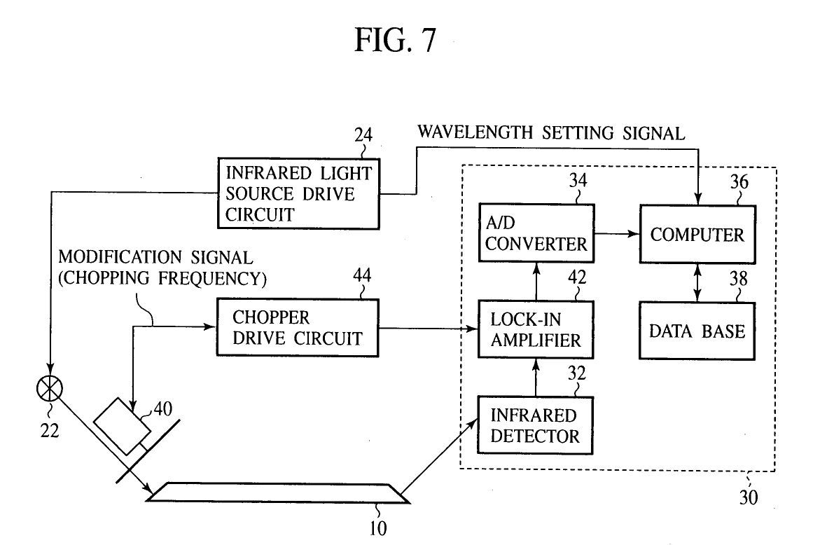

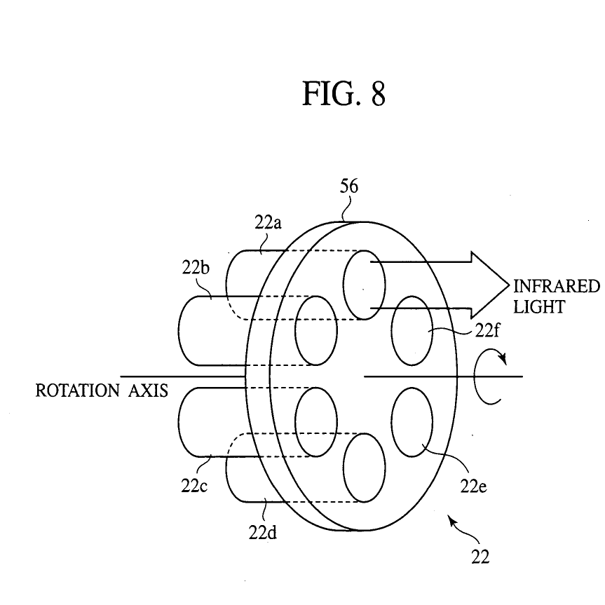

The environmental monitoring method and apparatus according to a second embodiment of the present invention will be explained with reference to FIGS. 7 and 8. The same members of the present embodiment as those of the chemical substance detecting method and apparatus according to the first embodiment shown in FIGS. 1 to 6 are represented by the same reference numbers not to repeat or to simplify their explanation.

FIG. 7 is a diagrammatic view of a structure of the chemical substance detecting apparatus according to the present embodiment. FIG. 8 is a diagrammatic view of a modification example of the infrared light source of the chemical substance detecting apparatus according to the present embodiment.

The chemical substance detecting apparatus according to the present embodiment is characterized in that, as shown in FIG. 7, an infrared light source 22 which can vary the emission wavelength is provided in place of the band-pass filter 50. Such constitution of the chemical substance detecting apparatus can also measure the absorbance characteristic of a chemical substance to be measured in an absorption wavelength range and in a wavelength range which is near this wavelength range and in which the absorption does not take place.

The infrared light source 22 of the variable wavelength type can be, e.g., a semiconductor light emitting element of the variable wavelength type or a photoparametric oscillation element using pseudo-phase matching.

As the semiconductor light emitting element of the variable wavelength type, infrared semiconductor lasers and infrared emitting diodes of the variable wavelength type are placed on the market. These elements can control the emission wavelength by controlling the injection current and temperature.

The photoparametric oscillation element using pseudo-phase matching is a element comprising a layer structure of ferroelectric nonlinear optical crystals of LiNbO₃ or LiTaO₃ or others stacked with the dielectric polarization directions periodically inverted by 180°, and can provide output light having a prescribed oscillation wavelength by the incidence of the excitation light (refer to, e.g., Oyo Buturi, vol. 67, No. 9, pp. 1046-1050 (1998)). This element can control the emission wavelength by controlling the, voltage and the temperature to be applied to the layer structure.

The infrared light source 22 is connected to an infrared light source drive circuit 24 and can have the emission wavelength controlled by the infrared light source drive circuit 24. The infrared light source drive circuit 24 controls the drive voltage and the injection current to be applied to the infrared light source 22 or controls the variable temperature element (not shown), such as a Peltier element or others, mounted on the light emitting element constituting the infrared light source 22 to thereby control the temperature of the light emitting element, whereby controls the wavelength of the infrared light to be emitted from the infrared light source 22.

The infrared light source drive circuit 24 is also connected to a computer 36. The infrared light source drive circuit 24 outputs wavelength setting signals for the infrared light emitted by the infrared light source 22 to the computer 36. Thus, a wavelength of the infrared light to be emitted by the infrared light source 22 and information of the detected infrared light can be related for the analysis.

In the chemical substance detecting apparatus according to the present embodiment, a chopper 40 is disposed between the infrared light source 22 and the infrared transmitting substrate 10 and is driven by a chopper drive circuit 44, and a lock-in amplifier 42 is disposed between an infrared detector 32 and an A/D converter 34. The chopping frequency of the chopper 40 is synchronized with the detection of the infrared light, whereby the S/N ratio can be high. The chopper 40, the chopper drive circuit 44 and the lock-in amplifier 42 are not essential.

In place of providing the chopper 40 and the chopper drive circuit 44, frequency modulation signals outputted by the infrared light source drive circuit 24 may be inputted to the lock-in amplifier 42 to use the frequency modulation signals as the synchronization signals.

Then, the chemical substance detecting method according to the present embodiment will be explained with reference to FIG. 7.

First, in the same way as in the chemical substance detecting method according to the first embodiment, the measurement in the reference state is performed.

First, the reference substrate without any chemical substance adsorbed to the surfaces, e.g., the substrate immediately after cleaned is loaded in the chemical substance detecting apparatus.

Then, infrared light exiting the infrared transmitting substrate 10 is detected by the infrared detector 32. At this time, an emission wavelength range of the infrared light to be emitted by the infrared light source 22 is changed to make the measurement at least twice. In the first measurement, infrared light of the wavelength of the absorption band characteristic of a chemical substance to be monitored is used in detecting the transmitted infrared light. In the second measurement, infrared light of a wavelength band which is near the absorption band characteristic of the chemical substance to be monitored and in which the absorption by the chemical substance does not take place is used in detecting the transmitted infrared light. Either of the two measurements described above may be made first.

A light quantity of the infrared light detected in the first measurement is stored in a data base 38 as, e.g., a light quantity S₀. A light quantity of the infrared light detected in the second measurement is stored in the data base 38 as, e.g., a light quantity R₀.

Then, the substrate in the measurable state is measured.

First, the infrared transmitting substrate 10, a substrate to be measured is loaded in the chemical substance detecting apparatus. The infrared transmitting substrate 10 may be positioned in an atmosphere to be measured to monitor a chemical substance contained in the atmosphere.

Then, infrared light emitted by the infrared light source 20 is incident on the infrared transmitting substrate 10. The infrared light incident on the infrared transmitting substrate 10 makes multiple internal reflections on the front and back surfaces of the infrared transmitting substrate 10 while probing and accumulating information of a chemical substrate adsorbed to the surfaces of the infrared transmitting substrate 10, and exits the infrared transmitting substrate 10 outside.

Then, the infrared light exiting the infrared transmitting substrate 10 is detected by the infrared detector 32. At this time, to measure a plurality of wavelengths, the infrared light of different emission wavelength bands is emitted by the infrared light source to make the measurement at least twice. In the first measurement, infrared light of a wavelength of the absorption band characteristic of a chemical substance to be monitored is used to detect the transmitted infrared light. In the second measurement, infrared light of a wavelength band which is near the absorption band of the chemical substance to be measured and in which the absorption by the chemical substance does not take place is used to detect the transmitted infrared light. Either of the above-described measurements may be performed first.

A light quantity of the infrared light detected in the first measurement is stored in the data base 38 as, e.g., a light quantity S₁′. A light quantity of the infrared light detected in the second measurement is stored in the data base 38 as, e.g., a light quantity R₁′.

Then, based on the light quantities S₀, R₀, S₁′, R₁′ stored in the data base 38, an absorbance A with the transmitted light quantity corrected is given. That is, the absorbance A can be computed by

A=−log₁₀(S₁′×(R₀/R₁′)/S₀).

Next, with reference to a calibration line stored in the data base 38, an adsorption amount of the chemical substance on the infrared transmitting substrate 10, or a concentration of the chemical substance in the atmosphere is computed.

As described above, according to the present embodiment, in the chemical substance detecting method comprising: applying infrared light to an infrared transmitting substrate; detecting the infrared light which has made multiple internal reflections inside the infrared transmitting substrate and exited the infrared transmitting substrate; and computing an adsorption amount of a chemical substance adsorbed to the infrared transmitting substrate based on an intensity of the detected infrared light, a first light quantity in a first wavelength range where no substantial absorption of the infrared light by the chemical substance takes place is measured in a reference state of the infrared transmitting substrate; a second light quantity in the first wavelength range is measured in a state of the infrared transmitting substrate with the chemical substance adsorbed to; and a light quantity ratio between the first light quantity and the second light quantity is considered to compute an adsorption amount of the chemical substance adsorbed to the infrared transmitting substrate, whereby even when a light quantity of the transmitted infrared light changes due to factors other than chemical substances adsorbed to the substrate, an adsorption amount of the a chemical substance can be precisely computed.

The currently available light emitting elements of the variable wavelength type cannot sweep the emission wavelengths in a wavelength region containing all wavelength ranges corresponding to molecular vibration wavelengths of functional groups. When a wide range of infrared wavelengths must be swept, the infrared light source 22 is constituted as exemplified below.

The light emitting element of the variable wavelength type can be controlled by electric signals and temperatures applied to the element itself as described above. The light emitting element is controlled by both electric signals and the temperatures, whereby the emission wavelength can be controlled in a wider range than singly by either of electric signals or temperatures. The temperature of the light emitting element can be controlled by controlling electric signals to be applied to a variable temperature element, such as a Peltier element, mounted on the light emitting element.

Otherwise, as exemplified in FIG. 8, an infrared light source 22 including a plurality of infrared light sources 22a-22f of different light emission wavelength ranges arranged concentrically on a rotary plate 56 is prepared, and the rotary plate 60 is rotated along the rotary axis to sequentially sweep the wavelengths of the infrared light emitted by the infrared light sources 22a-22f, whereby the emission wavelengths of the infrared light can be swept over a wide range of the wavelength ranges covered by the infrared light sources 22a-22f.

(A Third Embodiment)

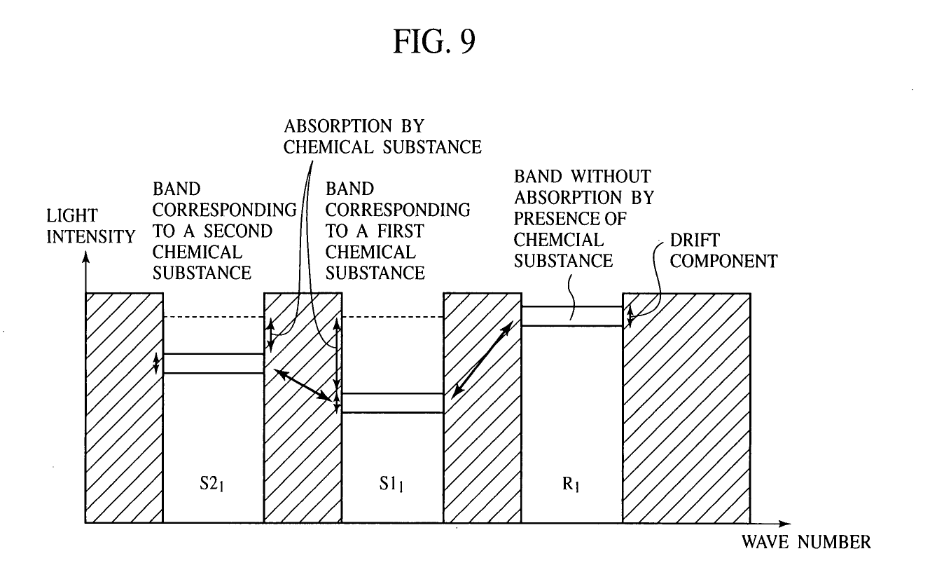

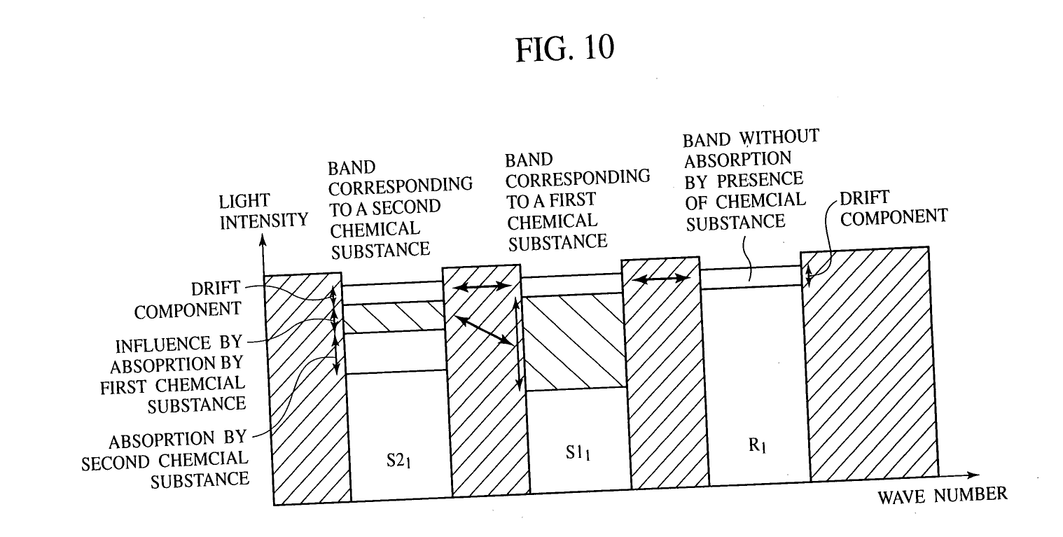

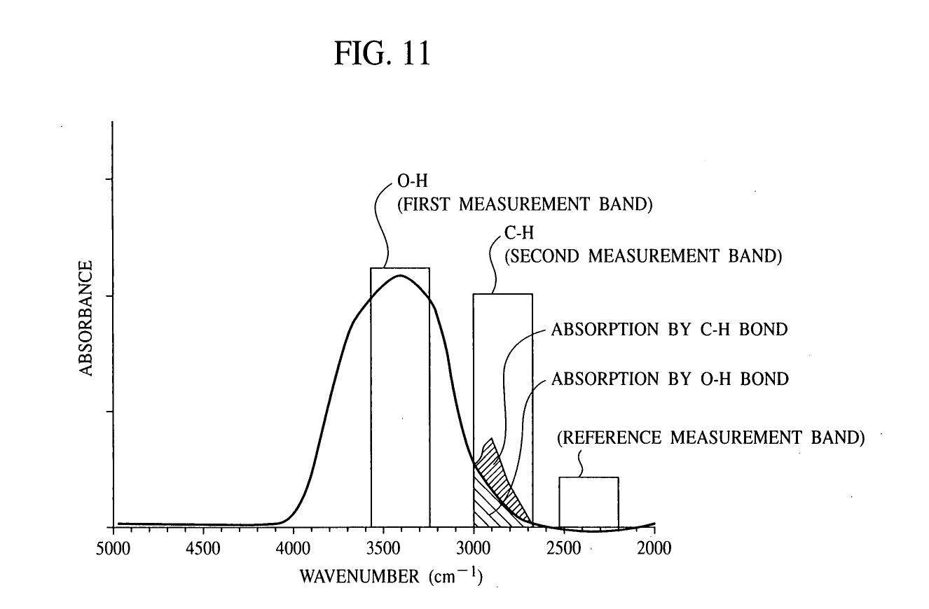

The chemical substance detecting method and apparatus according to a third embodiment of the present invention will be explained with reference to FIGS. 9 to 11. FIG. 9 is a view explaining the determination of a plurality kinds of chemical substances by the chemical substance detecting method according to the present invention. FIG. 10 is a view explaining the determination of chemical substances by the chemical substance detecting method according to the present embodiment. FIG. 11 is a view of an example of the infrared absorbance spectrum given by the chemical substance determination by the chemical substance detecting method according to the present embodiment.

In the first embodiment, one kind of chemical substance is determined, but a plurality of kinds of chemical substances can be determined. FIG. 9 shows the determination of two kinds of chemical substances, the first and the second chemical substances. As shown, light quantities of infrared light in bands corresponding to the first and the second chemical substances, which has exited the substrate in the reference state and the measurable state are measured. Similarly, light quantity in a band where the absorption by the presence of the chemical substances does not take place, in the reference state and the measurable state are measured to give a change rate of the light quantities between the reference state and the measurable state. Then, based on the change rate of the light quantities, by the same procedures as in the first embodiment, the light quantity in the band corresponding to the first chemical substance in the measurable state is corrected. Similarly, the light quantity in the band corresponding to the second chemical substance in the measurable state is corrected. Thus, by using the light quantities after corrected in the measurable state, in the same way as in the first embodiment, the first and the second chemical substances can be respectively correctly determined. Two kinds of chemical substances are here determined in the same way as in the first embodiment, but not only two kinds but also more kinds of chemical substances can be determined.

However, when bands corresponding to a plurality of kinds of chemical substances are near each other, the following problem often takes place. That is, the absorption of a chemical substance having a wide absorption band often influences the absorption in an adjacent band corresponding to a chemical substance. When the first and the second chemical substances are determined as exemplified in FIG. 10, the absorption by the first chemical substance whose absorption is in a wide band often influences the absorption in a band corresponding to the second chemical substance. Accordingly, when a plurality of kinds of chemical substances are determined, it is often necessary to consider the influence of the absorption in the adjacent band corresponding to the chemical substance.

The chemical substance detecting method according to the present embodiment determines with high precision a plurality of kinds of chemical substances, considering the influence of the absorption in the adjacent band corresponding to the chemical substance.

The determination of a plurality of kinds of chemical substances by the chemical substance detecting method according to the present embodiment will be explained by means of the example shown in FIG. 10, in which the first and the second chemical substances are determined. The chemical substance detecting method according to the present embodiment is applicable to the chemical substance detecting apparatus according to the first or the second embodiment.

First, light quantities of the infrared light in bands corresponding to the first and the second chemical substances, which exits the substrates in the reference state and the measurable state, are measured. Similarly, light quantities in the reference state and the measurable state in bands where the absorption by the chemical substances does not take place are measured to give a change rate of the light quantities between the reference state and the measurable state. Then, by the same procedures in the first embodiment, based on the change rate of the light quantity, the light quantity in the band corresponding to the first chemical substance and in the measurable state is corrected. Thus, based on the light quantity in the band corresponding to the first chemical substance and in the reference state, and the light quantity as corrected in the measurable state, a correct absorbed light quantity by the first chemical substance is determined in the same way as in the first embodiment.

Similarly, the light quantity in the band corresponding to the second chemical substance and in the measurable state is corrected based on the change rate of the light quantities in the band where the absorption due to the presence of the chemical substance does not take place. Then, in the band corresponding to the second chemical substance, an absorbed light quantity is given based on the light quantity in the reference state and the light quantity as corrected in the measurable state.

Furthermore, a part of the given absorbed light quantity in the band corresponding to the second chemical substance, which is influenced by the absorption by the first chemical substance, is removed. That is, the absorbed light quantity by the first chemical substance multiplied by a prescribed coefficient is removed from the absorbed light quantity as corrected in the band corresponding to the second chemical substance. The coefficient used here is given as follows.

Under ideal conditions, an absorbed light quantity in the band corresponding to the first chemical substance is measured on the infrared transmitting substrate with the first chemical substance alone present. At this time, concurrently therewith, an absorbed light quantity by the first chemical substance in the band corresponding to the second chemical substance is measured.

The same measurement is performed with concentrations of the first chemical substance on the infrared transmitting substrate changed to give relationships between the absorbed light quantity in the band corresponding to the first chemical substance and the absorbed light quantity in the band corresponding to the second chemical substance.

Then, based on the given relationships, a ratio of the absorbed light quantity in the band corresponding to the second chemical substance to the absorbed light quantity in the band corresponding to the first chemical substance is given as the coefficient.

Then, the second chemical substance is determined, based on the absorbed light quantity in the band corresponding to the second chemical substance with the influenced part by the absorption by the first chemical substance removed.

As described above, the chemical substance detecting method according to the present embodiment is characterized mainly in that when the absorption by a chemical substance having a wide absorption band influences the absorption in an adjacent band corresponding to a chemical substance, the determination is performed in consideration of the influence. Thus, even when a plurality of kinds of chemical substances are determined, the respective chemical substances can be precisely determined.

An example that the absorption of a chemical substance having a wide absorption band influences the absorption in an adjacent band corresponding to a chemical substance will be explained with reference to FIG. 11.

In the spectrum shown in FIG. 11, a wide absorbance spectrum of the infrared absorption by O—H groups is shown near 3400 cm⁻¹ as the center. This absorption is mostly by water. It is found that this wide range of absorption by O—H groups influences the absorption by C—H groups of organic substances near 2900 cm⁻¹ as the center.

In the case shown in FIG. 11, light quantities in the reference state and the measurable state are measured respectively in the band near 3400 cm⁻¹ as the center (the first measurement band), the band near 2900 cm⁻¹ as the center (the second measurement band) and the band near, e.g., 2400 cm⁻¹ as the center (the reference measurement band) which shows no absorption by the presence of a chemical substance. Following the above-described procedures, the light quantities in the absorption band by the O—H groups and the absorption band by the C—H groups both in the measurable state are corrected based on a change rate of the light quantities in the reference measurement band.

For the O—H groups, based on the light quantity in the reference state and the light quantity as corrected in the measurable state in the first measurement band, a correct absorbed light quantity by the O—H groups is given for the determination.

For the C—H groups, an absorbed light quantity is given based on the light quantity in the reference state and the light quantity as corrected in the measurable state both in the second measurement band. Then, by the above-described determination, a part influenced by the absorption by the O—H groups is removed from the given absorbed light quantity in the second measurement band. Thus, a correct absorbed light quantity by the C—H groups can be given. Then, based on the correct absorbed light quantity by the C—H groups given by removing the part influenced by the absorption by the O—H groups, the C—H groups are determined.

As described above, according to the present embodiment, in the chemical substance detecting method comprising: applying infrared light to an infrared transmitting substrate; detecting the infrared light which has made multiple internal reflections inside the infrared transmitting substrate and exited the infrared transmitting substrate; and computing an adsorption amount of a chemical substance adsorbed to the infrared transmitting substrate based on an intensity of the detected infrared light, a first light quantity in a first wavelength range where no substantial infrared absorption by chemical substances takes place, and light quantities in respective wavelength ranges where absorption by the respective plurality of kinds of chemical substances takes place are measured in the reference state of the infrared transmitting substrate; a second light quantity in the first wavelength range, and light quantities in the respective wavelength ranges where absorption by the respective plurality of kinds of chemical substances takes place are measured in the measurable state of the infrared transmitting substrate; the respective light quantities in the wavelength ranges where the absorption by the plurality of kinds of chemical substances in the measurable state are corrected based on a ratio between the first light quantity and the second light quantity; and the respective plurality of kinds of chemical substances adsorbed to the infrared transmitting substrate are determined based on the light quantities in the wavelength ranges where the absorption by the plurality of kinds of chemical substances take place in the reference state, and the light quantities as corrected in the wavelength ranges where the absorption by the plurality of kinds of chemicals take place in the measurable state, whereby a plurality of kinds of chemical substances can be concurrently identified and determined, and even when a light quantity of transmitted infrared light is changed due to factors other than chemical substances adsorbed to the substrate, adsorption amounts of the plurality of kinds of chemical substances can be precisely computed. In this determination, absorption of other chemical substances which influences a light quantity change between the reference state and the measurable state in the wavelength range where absorption takes place by one of a plurality of kinds of chemical substances is considered, whereby adsorption amounts of the plurality of kinds of chemical substances can be more precisely computed.

(Modified Embodiments)

The present invention is not limited to the above-described embodiments and can cover other various modifications.

For example, in the above-described embodiments, the chemical substance detecting apparatus is arranged to detect infrared light of a specific wavelength range by the infrared detector, but an infrared interferometer may be disposed before the infrared detector to obtain resonance absorbance spectrum. For example, the infrared light exiting the infrared transmitting substrate 10 is incident on the infrared interferometer and is converted to electric signals by the infrared detector, an interferogram converted to electric signals is converted to a wavelength (frequency) range by Fourier transform using a computer to thereby give a resonance absorbance spectrum in the wavelength range. When the infrared interferometer is used, a plurality of wavelength regions are separated from a detected resonance absorbance spectrum, and light quantities are given, whereby chemical substances can be analyzed by the same procedures in the above-described embodiment. The infrared interferometer (FT-IR apparatus) is expensive, and it is preferable to use the constitution used in the above-described embodiment for making the apparatus inexpensive.

In the first embodiment, in place of using the filter, the infrared detector 32 may comprise a plurality of infrared detecting elements of different detection wavelength ranges, and the respective detecting elements may measure absorbances in absorption wavelength ranges of chemical substances to be measured, and an absorbance in a wavelength range which is near the wavelength ranges and where the absorption does not take place. Otherwise, it is possible that spectroscopic means, such as a prism, a diffraction grating or others, is disposed before the infrared detector 32, whereby the infrared light incident on the infrared detector 32 is decomposed into a plurality of wavelength ranges, and the infrared light of the respective wavelength ranges is detected by discrete infrared detecting elements.

In the first embodiment descried above, in place of using the filter, the infrared detector 32 may be arranged to vary the detection wavelength range, whereby absorbances in absorption wavelength ranges characteristic of chemical substances to be measured and an absorbances in a wavelength range which is near the wavelength range and where the absorption does not take place are sequentially measured, changing the detection wavelength range.

### INDUSTRIAL APPLICABILITY

The chemical substance detecting method and apparatus according to the present invention are useful in monitoring various chemical substances present in environments at high speed and with high sensitivity so as to identify the generation source of the chemical substances, to control and administer amounts of their discharges to environments, and other purposes.

In the claims:

1. A chemical substance detecting method comprising the following steps of:
applying infrared light to an infrared transmitting substrate;
detecting the infrared light which has made multiple internal reflections inside the infrared transmitting substrate and exited the infrared transmitting substrate; and
computing an adsorption amount of a chemical substance adsorbed to the infrared transmitting substrate based on an intensity of the detected infrared light, wherein
a first light quantity in a first wavelength range where no substantial absorption of the infrared light by the chemical substance takes place is measured in a reference state of the infrared transmitting substrate;
a second light quantity in the first wavelength range is measured in a state of the infrared transmitting substrate with a quantity of the chemical substance changed; and
a light quantity ratio between the first light quantity and the second light quantity is considered to compute the adsorption amount of the chemical substance adsorbed to the infrared transmitting substrate.

2. A chemical substance detecting method according to claim 1, wherein
a third light quantity in a second wavelength range where the absorption of the infrared light by the chemical substance takes place is measured in the reference state of the infrared transmitting substrate;
a fourth light quantity in the second wavelength range is measured in the state of the infrared transmitting substrate with a quantity of the chemical substance changed; and
the fourth light quantity is corrected by using said light quantity ratio, and the adsorption amount of the chemical substance adsorbed to the infrared transmitting substrate is computed based on the third light quantity and the fourth light quantity as corrected.

3. A chemical substance detecting method according to claim 1, wherein
a third light quantity in a second wavelength range where the absorption of the infrared light by the chemical substance takes place is measured in the reference state of the infrared transmitting substrate by using an infrared light source having a fifth light quantity;
a fourth light quantity in the second wavelength range is measured in the state of the infrared transmitting substrate with a quantity of the chemical substance changed by using the infrared light source having a sixth light quantity which is the fifth light quantity corrected by using said light quantity ratio; and
the adsorption amount of the chemical substance adsorbed to the infrared transmitting substrate is computed based on the third light quantity and the fourth light quantity.

4. A chemical substance detecting method according to claim 1, wherein
a third light quantity in a second wavelength range where the absorption of the infrared light by the chemical substance takes place is measured in the reference state of the infrared transmitting substrate via a filter having a first pass characteristics;
a fourth light quantity in the second wavelength range is measured in the state of the infrared transmitting substrate with a quantity of the chemical substance changed via the filter having a second pass characteristics which is the first pass characteristics corrected by using said light quantity ratio; and
the adsorption amount of the chemical substance adsorbed to the infrared transmitting substrate is computed based on the third light quantity and the fourth light quantity.

5. A chemical substance detecting method according to claim 1, wherein
the chemical substance contains a plurality of kinds chemical substances;
the second wavelength range includes a plurality of wavelength ranges where the substantial absorption of the infrared light by the respective plurality of kinds of chemical substances takes place; and
the third light quantity and the fourth light quantity are measured in the respective plurality of wavelength ranges to compute adsorption amounts of the respective plurality of kinds of chemical substances.

6. A chemical substance detecting method according to claim 5, wherein
one of the plurality of kinds of chemical substances is determined in consideration of the absorption of the other of the plurality of kinds of chemical substances, which influences a change of the light quantities between the reference state and the measured state in a wavelength range where the absorption by said one chemical substance takes place.

7. A chemical substance detecting method according to claim 1, wherein
the first wavelength range is a wavelength range near the second wavelength range.

8. A chemical substance detecting method according to claim 1, wherein
a concentration of the chemical substance in the air is computed based on the adsorption amount of the chemical substance adsorbed to the infrared transmitting substrate.

9. A chemical substance detecting apparatus comprising:
an infrared transmitting substrate;
an infrared light source for applying infrared light to the infrared transmitting substrate; and
a chemical substance analyzing means for detecting the infrared light which has made multiple internal reflections in the infrared transmitting substrate and exited the infrared transmitting substrate, and computing an adsorption amount of the specific chemical substance adsorbed to the infrared transmitting substrate,
the chemical substance analyzing means computing an adsorption amount of the specific chemical substance adsorbed to the infrared transmitting substrate in consideration of a light quantity ratio between a first light quantity in a first wavelength range where no substantial absorption of the infrared light by the chemical substance takes place measured in a reference state of the infrared transmitting substrate, and a second light quantity in the first wavelength range measured in a state of the infrared transmitting substrate with a quantity of the chemical substance changed.

10. A chemical substance detecting apparatus according to claim 9, further comprising
a band-pass filter for passing selectively the infrared light in the first wavelength range or the infrared light in a second wavelength range which is near the first wavelength range and in which the absorption of the infrared light by the specific chemical substance takes place,
the chemical substance analyzing means analyzing the infrared light which has passed the band-pass filter.

11. A chemical substance detecting apparatus according to claim 10, wherein
the band-pass filter includes a first filter which passes selectively the infrared light of the first wavelength range, and a second filter which passes selectively the infrared light of the second wavelength range.

12. A chemical substance detecting apparatus according to claim 10, wherein
the band-pass filter can change the pass band to the first wavelength range and to the second wavelength range.

13. A chemical substance detecting apparatus according to claim 9, wherein
the infrared light source emits infrared light of the first wavelength range and infrared light of a second wavelength range which is a wavelength range near the first wavelength range and in which the absorption of the infrared light by the specific chemical substance does not take place.

14. A chemical substance detecting apparatus according to claim 13, wherein
the infrared light source includes a first light source for emitting infrared light of the first wavelength range, and a second light source for emitting infrared light of the second wavelength range.

15. A chemical substance detecting apparatus according to claim 13, wherein
the infrared light source can change the emission wavelength range to the first wavelength range and to the second wavelength range.

16. A chemical substance detecting apparatus according to claim 9, wherein
the chemical substance analyzing means includes an infrared detector which detects selectively the infrared light of the first wavelength range and the infrared light of a second wavelength range near the first wavelength range, in which the absorption of the infrared light by the specific chemical substance takes place.

17. A chemical substance detecting apparatus according to claim 16, wherein,
the infrared detector includes a first detecting element for detecting the infrared light of the first wavelength range, and a second detecting element for detecting the infrared light of the second wavelength range.

18. A chemical substance detecting apparatus according to claim 16, wherein
the infrared detector can change the detection wavelength range to the first wavelength range and to the second wavelength range.

19. A chemical substance detecting apparatus according to claim 9, wherein
the chemical substance contains a plurality of kinds of chemical substances;
the second wavelength range includes a plurality of wavelength ranges in which the substantial absorption of the infrared light by the respective plurality of kinds of chemical substances takes place; and
the chemical substance analyzing means corrects light quantities measured in the respective plurality of wavelength ranges in the state of the infrared transmitting substrate with the quantities of the chemical substances changed by using the light quantity ratio between the first light quantity and the second light quantity, and determines the respective plurality of kinds of chemical substances, based on the light quantities measured in the plurality of wavelength ranges in the reference state, and the light quantities as corrected in the plurality of wavelength ranges measured in the state of the infrared transmitting substrate with the quantities of the chemical substances changed.

20. A chemical substance detecting apparatus according to claim 19, wherein
the chemical substance analyzing means determines one of the plurality of kinds of chemical substances in consideration of the absorption of the other of the plurality of kinds of chemical substances, which influences a change of the light quantities between the reference state and the measured state in a wavelength range where the absorption by said one chemical substance takes place.
